(19) United States
(12) Patent Application Publication
(10) Pub. No.: US 2005/0096946 A1
(43) Pub. Date: May 5, 2005

(54) System and method for dynamically resolving travel arrangement problems based on changes in travel conditions

(75) Inventors: Janani Janakiraman, Austin, TX (US); David Bruce Kumhyr, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/697,915

(22) Filed: Oct. 30, 2003

(51) Int. Cl. G06F 17/60

(52) U.S. Cl. 705/5

(57) ABSTRACT

A system and method for automatically and dynamically adjusting travel arrangements based on changes to a traveler's itinerary are provided. With the system and method, a traveler makes initial travel arrangements and stores information regarding these travel arrangements in a travel itinerary database. The itinerary is then registered with a dynamic itinerary monitoring system. The dynamic itinerary monitoring system monitors all registered active itineraries by comparing information gathered regarding the current travel conditions of the traveler to the itinerary information stored in the travel itinerary database. If there are discrepancies between the current travel conditions and the established itinerary, the dynamic itinerary monitoring system determines how to resolve these discrepancies based on a traveler defined rule set. Based on this rule set, the dynamic itinerary monitoring system may initiate communications with vendor computing systems identified in the current traveler's itinerary in order to modify travel accommodations.

### BACKGROUND OF THE INVENTION

1. Technical Field

The present invention provides an improved data processing system in which travel arrangements may be dynamically modified based on changes in travel conditions. More specifically, the present invention provides a mechanism for automatically canceling existing travel accommodations and obtaining new travel accommodations based on a change in a traveler's itinerary.

2. Description of Related Art

individuals travel from location to location for many different reasons including work related reasons, vacation, and the like. Typically, travelers will establish a travel plan prior to embarking on their trip by setting up air flights, hotel accommodations, ground travel arrangements, entertainment, and the like, thereby generating an itinerary for the trip. These travel arrangements are set up under the assumption that each segment of the itinerary will be executed in an expected manner, e.g., an air flight will depart at a particular departure time and arrive at a particular arrival time.

However, it is often the case that the itinerary that is set up prior to the trip is not the itinerary that is experienced during the trip. For example, there may be delays in the airport, weather conditions that cause problems with travel arrangements, cancellation of entertainment arrangements, such as cancellations of live performances, non-availability of ground transportation, and other changes in the itinerary that may require that the travel adjust their arrangements.

Typically, such changes in travel arrangements required the traveler to request the assistance of other personnel to cancel existing arrangements and obtain new travel arrangements. For example, if a traveler's air flight arrived late, and the traveler's connecting flight was missed, the traveler would need to cancel the hotel accommodations at his destination and acquire hotel accommodations in his current location. This may lead to great frustration on the part of the traveler which may then be unleashed onto personnel at the airline, hotel, or the like.

Some systems have been developed for aiding in the changing of travel arrangements. For example, U.S. Pat. No. 6,496,568 provides a method and apparatus for providing automated notification to a customer when changes in real-time data occur. For example, airline customers may be notified of changes in airline information which affects their travel plans. While this system provides for notification of customers of the changes in airline information, there is no ability to make the necessary changes to a customer's travel arrangements to compensate for these changes in the airline information.

U.S. Pat. No. 5,832,451 provides an automated travel service management information system. This system provides a mechanism for compiling information regarding a business entity profile, an individual profile for customers, customer reservation services information from all available sources, and provides this information to a travel agent in processing a customer's travel request. While it is conceivable that this system may be used to modify travel arrangements, such modification would require the traveler to contact a travel agent and negotiate the new travel arrangements through human interaction. There is no ability to automatically negotiate new travel arrangements in response to changes in current travel conditions.

U.S. Pat. No. 5,021,953 provides a trip planner system that automatically constructs travel itineraries which conform to pre-stored reasonableness standards which includes a satisfactory check on whether a connection flight distance exceeds that of a possible direct flight by a preset distance or ratio. While this system aids in the preparation of an itinerary, there is no ability in this system to automatically negotiate new travel arrangements when it is dynamically determined that current travel conditions indicate that a change in an itinerary is necessary.

Thus, it would be beneficial to have a system and method for automatically making adjustments to travel arrangements when changes in a travel itinerary occur.

### SUMMARY OF THE INVENTION

The present invention provides a system and method for automatically and dynamically adjusting travel arrangements based on changes to a traveler's itinerary. With the present invention, a traveler makes initial travel arrangements and stores information regarding these travel arrangements in a travel itinerary database. In one particular embodiment, the travel arrangements may be made via a web site, travel agency, or the like, such that the information about the travel arrangements is automatically stored in a travel itinerary database. The itinerary is then registered with a dynamic itinerary monitoring system.

The itinerary information stored in the travel itinerary database will include a start date and time, an end date and time, and a plurality of records identifying specific travel arrangements made by the traveler. Each of these specific travel arrangements may include their own start and end times as well as contact information, confirmation numbers, account numbers, location information, and the like.

The dynamic itinerary monitoring system monitors all registered active itineraries. That is, active itineraries are identified based on their start times, end times, and the current time. Itineraries that have started but have not yet ended are considered active itineraries. For active itineraries, the dynamic itinerary monitoring system compares information gathered regarding the current travel conditions of the traveler to the itinerary information stored in the travel itinerary database. The information gathered regarding the current travel conditions may be obtained from various sources of travel information. For example, flight information may be obtained from the Air Route Traffic Control Center (ARTCC) computing systems which indicates delays, cancellations, and the like. Similar such travel condition information may be obtained from other systems including Amtrak computing systems, Greyhound Bus lines computing systems, cruise line computing systems, and the like.

If there are discrepancies between the current travel conditions and the established itinerary, the dynamic itinerary monitoring system determines how to resolve these discrepancies based on a traveler defined rule set. Based on this rule set, the dynamic itinerary monitoring system may initiate communications with vendor computing systems identified in the current traveler's itinerary in order to modify travel accommodations. In addition, based on this rule set, the dynamic itinerary monitoring system may initiate communications with vendor computing systems that are not identified in the current traveler's itinerary to acquire new travel accommodations, if necessary.

In this way, as travel conditions change, based on information obtained from sources of travel condition information, a traveler's established itinerary, and the traveler's rule set, modifications can be made to the travel accommodations originally established by the traveler in an automatic and dynamic manner without requiring the traveler to be involved in the changing of the travel accommodations. Once the travel accommodations are modified to take into account the changes in the travel conditions, the traveler's itinerary may be updated to reflect the modifications in travel accommodations and notices of the travel accommodation modifications may be transmitted to a device associated with the traveler.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed data processing system in which the present invention may be implemented;

FIG. 2 is an exemplary block diagram of a server computing device in which aspects of the present invention may be implemented;

FIG. 3 is an exemplary block diagram of a client computing device in which aspects of the present invention may be implemented;

FIG. 4 is an exemplary diagram illustrating an information flow according to one exemplary embodiment of the present invention;

FIG. 5 is an exemplary block diagram of a travel itinerary monitoring system in accordance with one exemplary embodiment of the present invention;

FIG. 6 is an exemplary diagram illustrating a travel itinerary database data structure in accordance with one exemplary embodiment of the present invention;

FIG. 7A is an exemplary diagram illustrating a graphical user interface for inputting a user established rule set in accordance with one exemplary embodiment of the present invention;

FIG. 7B is an exemplary diagram illustrating a graphical user interface for inputting user established preferences in accordance with one exemplary embodiment of the present invention;

FIG. 8 is an exemplary diagram illustrating a display of a notification on a traveler's computing device in accordance with one exemplary embodiment of the present invention; and

FIG. 9 is flowchart outlining an exemplary operation of one exemplary embodiment of the present invention

### DETAILED DESCRIPTION OF THE PREFERRED EMBODIMENT

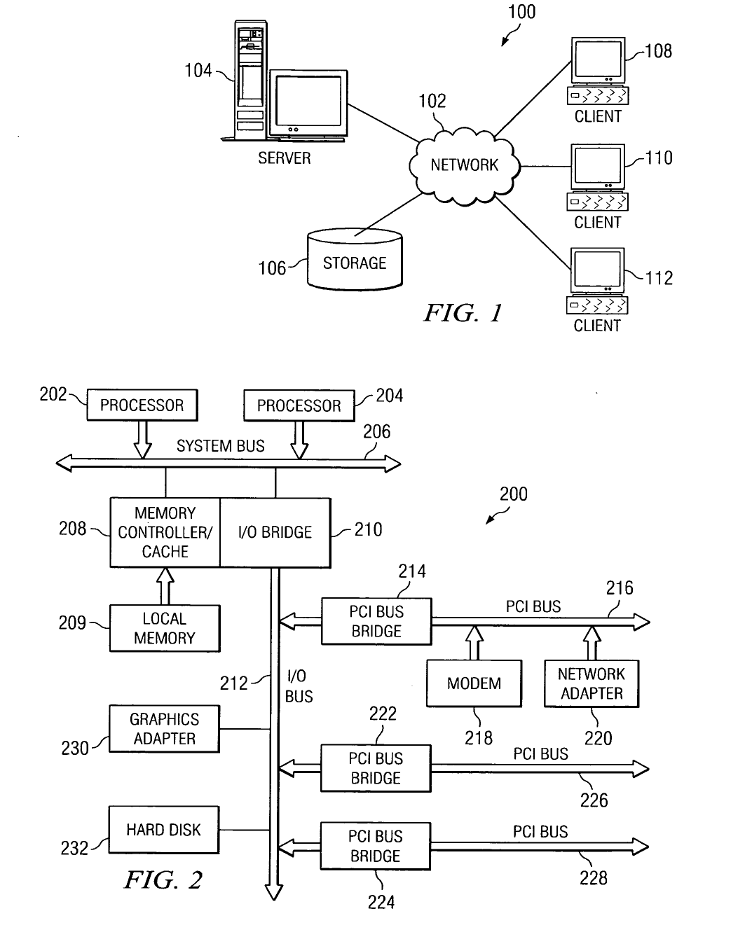

As mentioned above, the present invention provides a mechanism for dynamically monitoring and adjusting travel itineraries to determine if changes in travel arrangements are required and then making those changes in travel arrangements. The present invention is preferably implemented in a distributed data processing system in which information is obtained from a plurality of sources in order to perform the functions of dynamic monitoring and adjustment of travel itineraries based on current travel conditions. Therefore, the following description with regard to FIGS. 1-3 is intended to provide a general description of an exemplary distributed data processing system in which the present invention may be implemented.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pseries system, a product of International Business Machines Corporation in Armonk, N.Y., running the Advanced Interactive Executive (AIX) operating system or LINUX operating system.

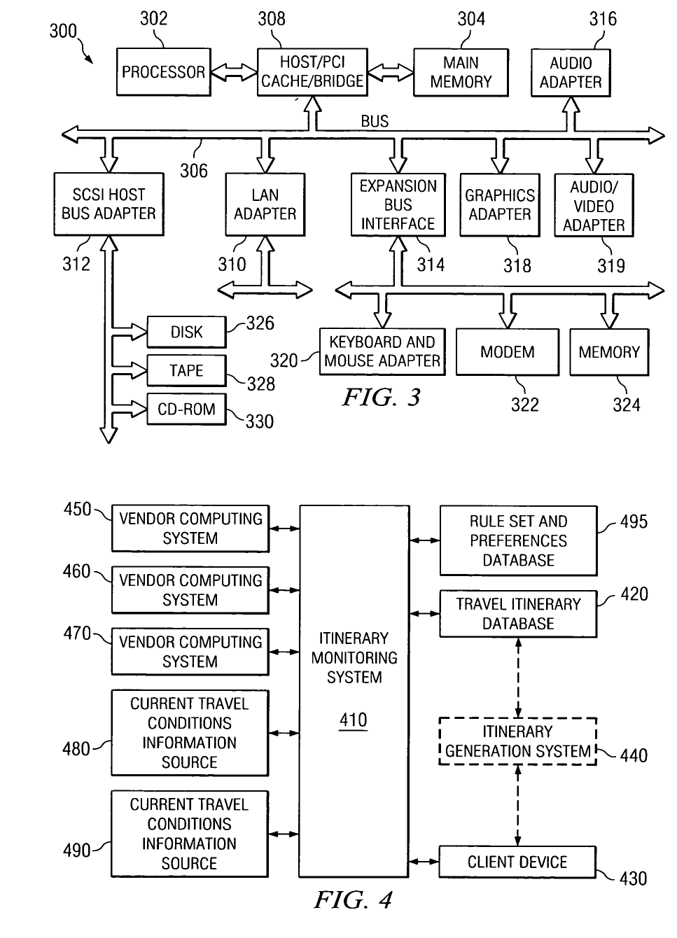

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As mentioned above, the present invention provides a system and method for automatically and dynamically adjusting travel arrangements based on changes to a traveler's itinerary. With the present invention, a traveler makes initial travel arrangements and stores information regarding these travel arrangements in a travel itinerary database. For example, referring again to FIG. 1, a traveler may use a client device, such as client device 108, to log onto a travel itinerary server, such as server 104, to make travel arrangements or simply to input information regarding the travel itinerary for the traveler.

In a preferred embodiment, the travel itinerary server is associated with a travel agency or other type of travel services provider and has server applications that permit the user of a client device to interact with the travel itinerary server to select and reserve travel accommodations. For example, a system such as that described in U.S. Pat. No. 5,832,451 and/or U.S. Pat. No. 5,021,953 could be used to establish a travel itinerary. As various travel accommodations are reserved, information about these travel accommodations is input to a travel itinerary database for the traveler.

For example, a user of the client device 108 may log onto the server 104 in an effort to reserve travel accommodations for an upcoming vacation. The server 104 preferably provides one or more web forms for obtaining user information, such as name, address, telephone number, credit card information, user identifier, password, and the like. In addition, one or more web forms may be utilized to obtain information regarding the travel accommodations that the user wishes to reserve. Web forms and server applications for reserving travel accommodations are generally known in the art. For example, Travelocity™, American Airlines™, Hotels.com™, and a plethora of other entities provide web sites through which users may acquire travel accommodations.

In one preferred embodiment of the present invention, the server 104 may act as a portal to other servers that provide server applications, web forms, and the like, for acquiring travel accommodations. In this way, the server 104 may provide a central site through which other web sites may be accessed and their information compiled by the server 104. An example of a web portal is, for example, the Upromise™ web site through which users may purchase items from other vendor web sites while obtaining credits in a Upromise™ account.

As travel accommodations are finalized, i.e. the user completes a transaction to reserve travel accommodations, information about the reservation of the travel accommodations is stored in a travel itinerary database for the user. The information about the travel accommodations is information sufficient for determining if current travel conditions require a change in the travel accommodations and to provide contact information for canceling or altering the travel accommodations when travel conditions warrant such modifications to the user's travel itinerary. Examples of such information include, airline identifier, flight number, confirmation number, departure time, arrival time, seat type, number of seats, connecting flight information, hotel identifier, check-in time, check-out time, number of beds, type of beds, type of room, etc. All this information is stored in records associated with a user's itinerary in a travel itinerary database, such as storage system 106.

In an alternative embodiment, rather than requiring the user to reserve the travel accommodations via the server 104, the server 104 may provide one or more web forms through which the user may enter information about the travel accommodations that the user has reserved. This information may then be stored in the travel itinerary database.

In addition to providing mechanisms through which the user of a client device may reserve travel accommodations or enter information about reserved travel accommodations, the server 104 may include server applications for selection of rule sets and preferences for travel accommodations. The rule sets include rules for determining how and when to resolve differences between an established travel itinerary for a user and current travel conditions of the user. For example, the rule sets may include rules that define difference conditions between the established travel itinerary and current travel conditions that result in a change in travel accommodations being necessary. In addition, the rules may include designations of how the travel accommodations are to be modified.

Thus, an exemplary rule may include, for example, if the flight arrival time is more than 30 minutes later than travel itinerary flight arrival time, renegotiate hotel accommodations. With such a rule, a current travel condition, i.e. the current estimated flight arrival time is compared to the travel itinerary flight arrival time. If the difference between the two flight arrival times is determined to be greater than 30 minutes, then the travel itinerary information stored in the travel itinerary database is used to contact the hotel where the user reserved a room and renegotiate the check in time, or the like.

Some rules may require that travel accommodations be modified in a more complex manner than simply changing a check in time. For example, under some conditions, existing travel accommodations may need to be canceled and new travel accommodations with the same or different vendors may need to be obtained. For this reason, the server 104 may provide one or more web applications and web forms for entering user preferences regarding travel accommodations. For example, the user may enter that for hotel accommodations, the user prefers a specific vendor, a particular type of room, a particular bed type, wishes to use a particular credit card, and the like. These preferences, along with information obtained from the established travel itinerary, may be used to negotiate new travel accommodations with the same or a different vendor.

In operation, the server 104 obtains information about a user's travel itinerary from the user or as part of the processing of a user's reservation of travel accommodations via the server 104. This information may be stored in a travel itinerary database 106 for later use in monitoring the travel itinerary for any needed changes due to current travel conditions.

Periodically, the server 104 checks the existing itineraries in the travel itinerary database 106 to identify the travel itineraries that are currently active. By currently active what is meant is that the current time is equal to or greater than a starting time of the travel itinerary. The starting time of the travel itinerary is the first temporally occurring date and time in the itinerary. Typically, this may be a flight departure time, train departure time, or the like. From the starting time of the travel itineraries, it can be determined which travel itineraries are currently being executed by the users, i.e. the travelers.

Information from travel condition sources is also obtained by the server 104. These travel condition sources may include, for example, computer systems associated with transportation companies or government agencies that provide current information about the progress of transportation vehicles associated with those companies or government agencies. Of course, the travel condition sources are not limited to transportation companies and government agencies. Other sources of information, such as hotel company computing systems, rental car computing systems, and the like, may supply information that may be used to determine if portions of the travel itinerary for a traveler are being executed in accordance with the established travel itinerary. In one exemplary embodiment, the travel condition sources include the Air Route Traffic Control Center (ARTCC) computing systems which provide information about the current situations of flights, estimated departure times, estimated times of arrival of flights, cancellations, and the like. Similar information may also be obtained from airline computer systems as well. From this information, it can be determined whether the transportation aspects of the travel itinerary are being performed according to the schedule set out in the travel itinerary.

Discrepancies between the current travel conditions, as determined from the current travel condition sources, and the travel itinerary may be identified by a comparison of the current travel conditions with the travel itinerary. For example, from the information supplied by the ARTCC computing systems, it can be determined that a particular flight has an estimated time of arrival of 2:15 pm. From the travel itinerary for the user, it can be determined that the flight was supposed to arrive at its destination at 1:30 pm. By comparing these times, it can be determined that there is a delay of 45 minutes.

Having compared the current travel conditions to the established travel itinerary to identify the discrepancies between the two, user established rules may be applied from rule sets associated with the user. That is, the travel itinerary stored in the travel itinerary database has an associated user, or traveler, identifier that may be used to lookup a corresponding rule set for the user in a rule set storage device. The rules of the rule set may then be applied to the discrepancies found between the current travel conditions and the travel itinerary to determine if and how to resolve these discrepancies.

For example, a rule may be provided in the rule set for the user that if the flight is delayed by more than 30 minutes, and there is less than 5 minutes between the arrival time of the flight and the departure time of a connecting flight, that a new flight to the destination city is to be negotiated with the airline company. Thus, in the above situation where the flight is delayed by 45 minutes, if the connecting flight leaves the airport at 2:00 pm, then by application of this rule, the server 104 would enter into a negotiation with the airline computing system to obtain an alternate flight to the traveler's destination. The server 104 may contact the airline computing system by way of the contact information stored in the travel itinerary of the travel itinerary database.

The negotiation of new travel accommodations, such as a new connecting flight, is governed by the parameters of the existing travel itinerary and the preferences established by the user. That is, the negotiation will attempt to obtain alternative travel accommodations that most closely approximate the previously established travel accommodations. Thus, if the connecting flight departed at 2:00 pm, was an American Airlines flight, and the seat was a coach seat, the negotiation will attempt to obtain a seat on a new flight that departs as close to 2:00 pm as possible, is with the same airline, and has the same type of seat assignment. However, it may not be possible to obtain a comparable travel accommodation. Thus, the negotiation may further include contacting other vendors, such as Delta Airlines, to try to obtain the best match of alternative accommodations to the previously established travel accommodations.

In obtaining new accommodations that best match the existing travel accommodations, choices between alternatives may be resolved based on the user established preferences. Thus, for example, if a first flight having a departure time that is within 1 hour of the original departure time of the connecting flight is available, but the only seat available is in first class seating, and a second flight having a departure time that is 4 hours from the original departure time of the connecting flight is available, and there are available seats in coach seating, then the user preferences may be used to determine which of these flights to select. For example, the user may wish to select, based on the user's established preferences, the later flight in order to obtain coach seating and not have to pay the additional cost for first class seating.

There are many different types of existing computing systems that permit negotiation in an electronic business environment. For example, U.S. Pat. No. 5,991,740 issued to Messer on Nov. 23, 1999, entitled “Data Processing System for Integrated Tracking and Management of Commerce Related Activities on a Public Network,” U.S. Pat. No. 6,336,105 issued to Conklin e al. on Jan. 1, 2002, entitled “System and Method for Representing Data and Providing Electronic Non-Repudiation in Negotiations System,” and U.S. Pat. No. 6,553,347 issued to Tavor et al. on Apr. 22, 2003, entitled “Automatic Virtual Negotiation,” each describe various types of negotiation systems, features of which may be incorporated into the negotiation engine of the present invention to perform negotiation of alternative travel arrangements based on a current travel itinerary and user preferences.

In addition, Hammer et al.; “The IDEAL Approach to Internet-Based Negotiation for E-Business,” 16^{th} International Conference on Data Engineering, Feb. 28^{th} to Mar. 3^{rd}, 2000, p. 666, which is hereby incorporated by reference, describes another computer based negotiation system which performs negotiation based on matching constraints included in proposal and counter-proposal messages. In short, any type of negotiation scheme may be used with the present invention so long as the negotiation is based on constraints and decisions governed by a current travel itinerary and user established preferences.

Once a satisfactory alternative travel accommodation is reserved for the traveler based on the negotiation discussed above, existing travel accommodations that have been replaced by the alternative travel accommodations may be canceled. Thus, for example, the server 104 may contact the vendor computing systems for the existing travel accommodations and negotiate the cancellation of these existing travel accommodations.

A notification may then be sent to the traveler via a traveler's portable computerized communication device, e.g. a personal digital assistant (PDA), a computer enabled wireless telephone, or a communication may be sent to a conventional communication device, such as a recorded message being sent to a wireless telephone or the like. In one exemplary embodiment, notifications may be sent in a similar manner to that described in U.S. Pat. No. 6,496,568. In one exemplary embodiment, seat assignment information may be obtained from an airline computer system, the contact information for the airphone corresponding to the seat assignment may then be obtained from the airline computer system, and a recorded message may be sent to the traveler via the identified airphone.

The notification preferably includes information regarding the new travel accommodations that have been secured for the traveler as well as an identification of the travel accommodations that have been canceled. This notification may include contact and location information for the vendor of the new travel accommodations so that the traveler may contact the vendor for additional information if necessary.

Thus, the present invention provides an automated mechanism for determining, in real-time, when changes in travel accommodations are necessary based on discrepancies between current travel conditions and an established travel itinerary. The affect of the travel discrepancies may be resolved with respect to downstream travel accommodations set forth in the travel itinerary by performing renegotiation of these travel accommodations to obtain alternative travel accommodations that most closely match the previously held travel accommodations. Notifications of the changes in the travel accommodations may then be sent to the traveler to inform them of the new travel accommodations.

FIG. 4 is an exemplary block diagram illustrating an information flow according to one exemplary embodiment of the present invention. As shown in FIG. 4, as shown in FIG. 4, the center of the information flow is the itinerary monitoring system 410 which is used to obtain information about a user's travel itinerary, monitor the execution of the itinerary to determine if changes in travel accommodations are to be made, to negotiate new travel accommodations as needed, and to notify the user when new travel accommodations have been successfully obtained.

The itinerary monitoring system 410 may obtain travel itinerary information from the travel itinerary database 420. This travel itinerary information in the travel itinerary database 420 may be compiled through interactions by a user of client device 430 with the itinerary monitoring system 410 to establish travel accommodations with vendors or may be generated by a separate itinerary generation system 440 that is not otherwise affiliated with the itinerary monitoring system 410.

In either case, the itinerary monitoring system 410 retrieves travel itinerary information from the database 420 and identifies which itineraries are currently active. That is, the itinerary monitoring system 410 compares a current time with the starting times and ending times of the itineraries to determine which itineraries are currently being executed but have not yet been completed. The active itineraries are then registered with the itinerary monitoring system 410 as itineraries to be monitored. This process may be repeated on a periodic basis.

Current travel condition information is obtained from one or more current travel condition information sources 480-490. Attributes in the current travel condition information are correlated with attributes in the active itineraries and are compared. Thus, for example, the estimated time of arrival of flight AA3456 in the current travel condition information obtained from, for example, the American Airlines computing system, may be compared to the estimated time of arrival of flight AA3456 in the established itinerary. Any discrepancies between the current travel conditions and the established itinerary are identified and stored.

Thereafter, the itinerary monitoring system 410 obtains the rule set and user preferences from the rule set and preferences database 495, for the user identified in the itinerary that has discrepancies between the current travel conditions and the itinerary. The rule set for the user is applied to the discrepancies to determine if and how these discrepancies are to be resolved. The resolution of these discrepancies may involve negotiating with vendor computing systems 450-470 to modify, cancel, and/or obtain new travel accommodations from these vendors.

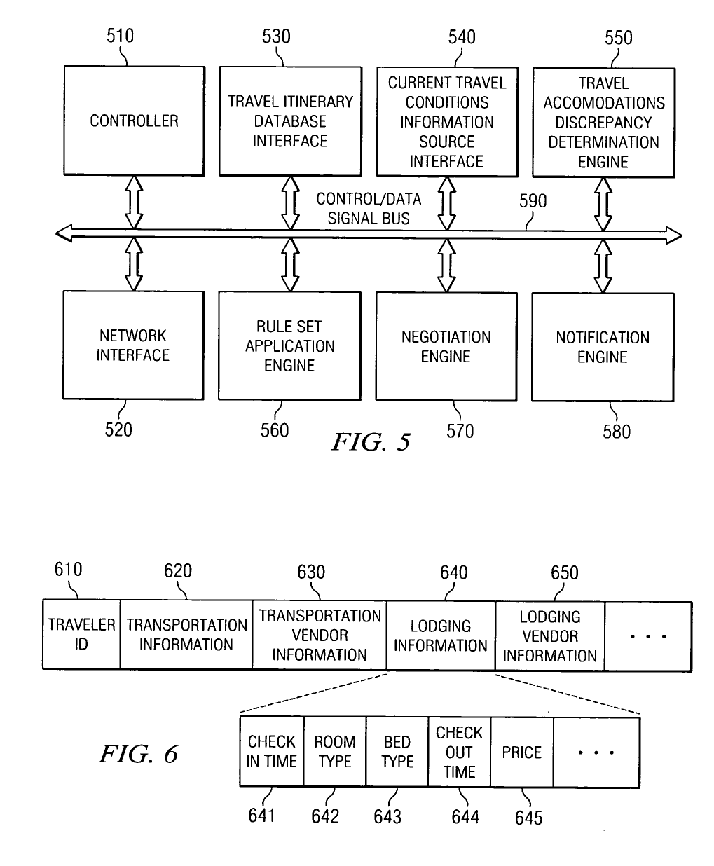

FIG. 5 is an exemplary block diagram of a travel itinerary monitoring system in accordance with one exemplary embodiment of the present invention. The elements shown in FIG. 5 may be implemented in hardware, software, or any combination of hardware and software. In a preferred embodiment the elements of FIG. 5 are implemented as software instructions executed by one or more data processing devices.

As shown in FIG. 5, the travel itinerary monitoring system includes a controller 510, a network interface 520, a travel itinerary database interface 530, a current travel conditions information source interface 540, a travel accommodations discrepancy determination engine 550, a rule set application engine 560, a negotiation engine 570, and a notification engine 580. The elements 510-580 are in communication with one another via the control/data signal bus 590. Although a bus architecture is shown in FIG. 5, the present invention is not limited to such and any architecture that facilitates the communication of control/data information between the elements 510-580 may be used without departing from the spirit and scope of the present invention.

The controller 510 controls the overall operation of the travel itinerary monitoring system and orchestrates the operation of the other elements 520-580. The network interface 520 provides a communication mechanism through which the travel itinerary monitoring system may receive input from a user via the user's client device and transmit notifications to a user's communication device. The travel itinerary database interface 530 provides a communication interface through which itinerary data may be stored in, and retrieved from, the travel itinerary database.

The current travel conditions information source interface 540 provides a communication interface for communicating with travel condition information sources to thereby obtain travel condition information. While a separate interface 540 is shown for communicating with the current travel condition information sources, this communication could also be performed through network interface 520 such that a separate interface is not necessary.

In operation, the controller 510 may receive user input via the network interface 520 to identify or obtain travel accommodations. Information about these travel accommodations is stored in the travel itinerary database via the interface 530. In addition, at periodic times, the itinerary information may be retrieved from the travel itinerary database via the interface 530 and provided to the controller 510. In addition, at periodic times, current travel conditions information may be retrieved from the current travel conditions information sources via the interface 540.

The travel accommodations discrepancy determination engine 550 compares the current travel conditions information with the itinerary information of active itineraries to identify any discrepancies. The discrepancies are provided to the rule set application engine 560 which applies a user's rule set, obtained via the network interface 520 from a rule set and user parameter database, to the discrepancies to determine if and how the discrepancies are to be resolved. If the resolution of the discrepancies requires negotiation of the travel accommodations, the negotiation engine 570 is informed of the elements of the itinerary that need to be negotiated and the user preferences for negotiating these elements.

Once the discrepancies have been resolved, the itinerary in the travel itinerary database is updated to reflect the new travel accommodations that were negotiated. In addition, the controller 510 may instruct the notification engine 580 to transmit a notification to a user's communication device. The contact information for the user's communication device may be stored, for example, in the user's preferences retrieved from the rule set and user preferences database.

FIG. 6 is an exemplary diagram illustrating a travel itinerary database data structure in accordance with one exemplary embodiment of the present invention. As shown in FIG. 6, the travel itinerary database data structure includes a field 610 for storing a traveler ID, fields 620 for storing transportation information, fields 630 for storing transportation vendor information, fields 640 for storing lodging information, fields 650 for storing lodging vendor information, and the like.

The traveler ID 610 is the principle manner by which the itinerary is correlated with user rule sets and user preferences. The transportation information fields 620 and lodging information fields 640 provided detailed information about the particular travel accommodations reserved by the traveler as part of this itinerary. The transportation vendor information fields 630 and the lodging vendor information fields 650 provide contact and location information as well as other information used to perform negotiations with vendor computing systems, for the vendor providing the travel accommodations in the related fields 620 and 640.

As shown in FIG. 6, the fields 620-650 may include a plurality of subfields that store specific information for that particular element of the itinerary. For example, in the lodging information fields 640, subfields 641-645 are provided for identifying a check in time, room type, bed type, check out time, price, etc. All of this information may be entered by the user or may be automatically compiled during a session with the user in which the user establishes the travel accommodations. It should be appreciated that additional information other than that explicitly shown in FIG. 6 may be included in an itinerary data structure without departing from the spirit and scope of the present invention.

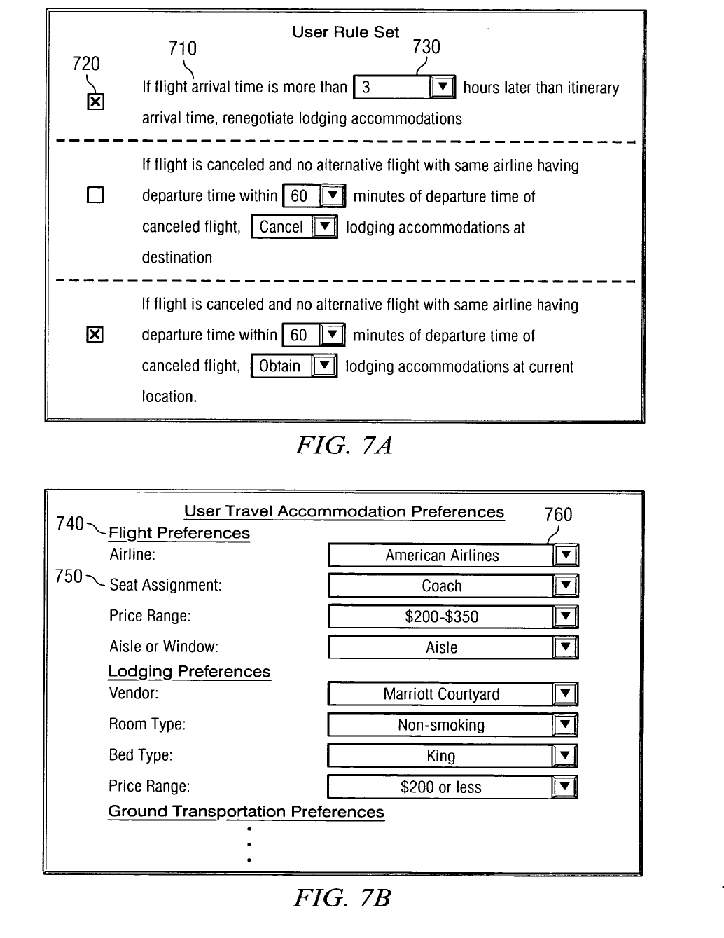

FIG. 7A is an exemplary diagram illustrating a graphical user interface for inputting a user established rule set in accordance with one exemplary embodiment of the present invention. The graphical user interface shown in FIG. 7A may be provided by the travel itinerary monitoring system, or a separate system, for establishing a user rule set that is to be applied to discrepancies in current travel conditions and an established itinerary. As shown in FIG. 7A, the graphical user interface has a series of rule statements 710 having check boxes 720 that allow the user to select which rules are to be applied. In addition, the rule statements may include fields 730 for designating parameters of the rule. Although these fields 730 are illustrated as pull-down selection menus, the present invention is not limited to such and the rule parameters may be entered or selected in any known manner.

Through the selection of rules that are to be applied and the parameters of these rules, the user may establish a rule set that includes one or more rules that are to be applied to discrepancies between current travel conditions and a traveler's itinerary. The rule set may be stored as a data structure that identifies the conditions that warrant action based on the application of the rule and the type of action that is to be performed when the conditions are satisfied. The rule set may be stored along with user preferences in manner by which the rule set and the user preference are indexed by the same user ID under which the travel itinerary is stored so that there is a common link between the stored information.

FIG. 7B is an exemplary diagram illustrating a graphical user interface for inputting user established preferences in accordance with one exemplary embodiment of the present invention. As shown in FIG. 7B, the graphical user interface includes a plurality of preference categories 740 for setting preferences with regard to different travel accommodations. Parameters 750 associated with these different travel accommodations are listed with fields 760 providing a mechanism by which a user may enter or select the value for the parameters 750 that are preferred by the user. These preferences may then be stored in a data structure for later use by the negotiation engine when negotiating modified or new travel accommodations.

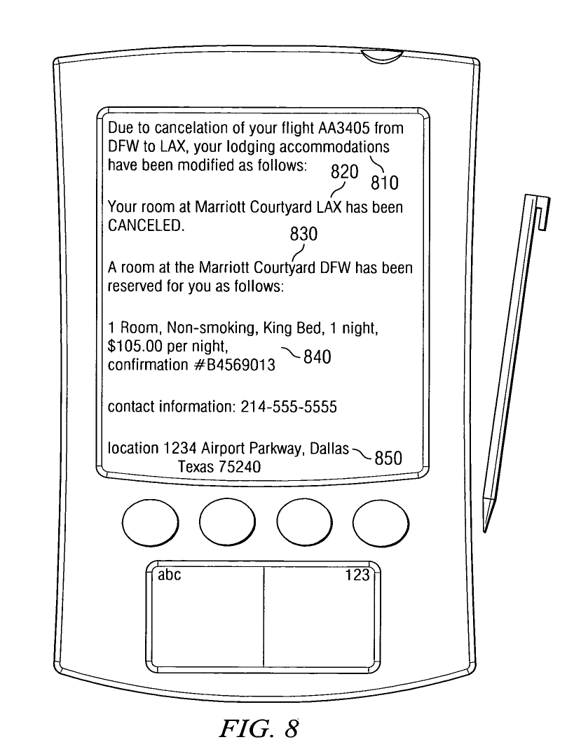

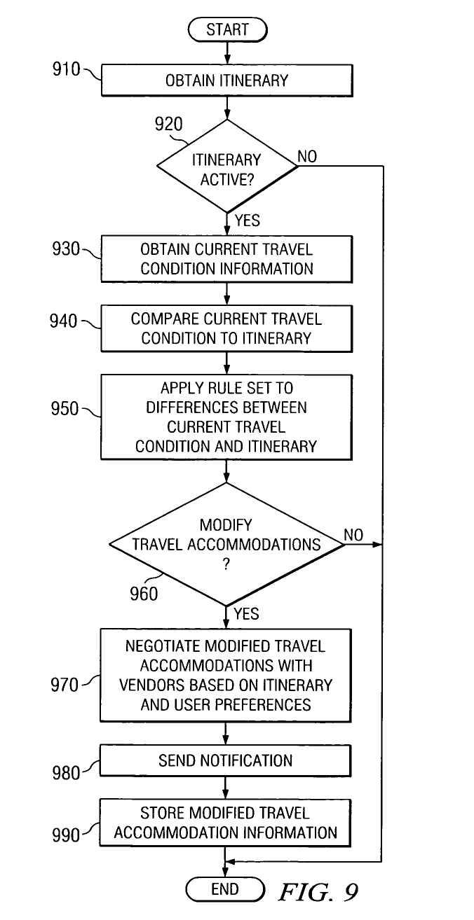

FIG. 8 is an exemplary diagram illustrating a display of a notification on a traveler's communication device in accordance with one exemplary embodiment of the present invention. The notification shown in FIG. 8 may be sent to the user's communication device in response to the successful completion of modifications to a user's itinerary in response to a determination that the current travel conditions diverge from the established itinerary by a requisite amount. The user's communication device may be identified based on information stored in the user's preferences data structure, for example.

The information contained in the notification includes a statement as to the reason from the notification 810, a statement as to the current disposition of the previously held travel accommodations 820, a statement identifying the new travel accommodations obtained 830, details of the new travel accommodations 840, and vendor contact and location information 850 of course, the notification depicted is only exemplary and more or less information than that shown in FIG. 8 may be made part of the notification without departing from the spirit and scope of the present invention.

In addition, while FIG. 8 illustrates this notification to be a visual notification sent to a personal digital assistant, the present invention is not limited to such. Rather, the notification may be sent to any communication device that is associated with a particular user/traveler. Thus, a visual notification may be sent to a user's wireless enabled laptop computer, a computerized wireless telephone, or the like. Alternatively, the notification may be audible and may be provided via a prerecorded message that is output to a user's wireless telephone, an airphone, or the like.

FIG. 9 is flowchart outlining an exemplary operation of one exemplary embodiment of the present invention. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

The operation shown in FIG. 9 is with respect to a single itinerary and for a single iteration of the travel itinerary monitoring system. The operation shown in FIG. 9 may be repeated for each additional itinerary retrieved from the travel itinerary database and may be repeated for each travel itinerary and each iteration at which the travel itinerary monitoring system checks the current travel conditions against active itineraries.

As shown in FIG. 9, the exemplary operation beings by obtaining itinerary information (step 910). A determination is then made as to whether the itinerary is active (step 920). If not, the operation terminates. If the itinerary is active, the current travel condition information pertaining to that itinerary is obtained (step 930). The current travel condition information is then compared to the itinerary so that any discrepancies are identified (step 940).

The traveler's rule set is then applied to any differences identified (step 950) and a determination is made as to whether the travel accommodations set forth in the itinerary need to be modified based on an application of the rule set to the differences (step 960). If not, the operation terminates. Otherwise, a negotiation with vendors of travel accommodations is instigated in order to obtain modified travel accommodations (step 970). These negotiations are governed by the criteria set forth in the original itinerary and the user's established preferences for travel accommodations. Once the negotiations have concluded, a notification is sent to the user's communication device indicating the new travel accommodations (step 980). The modified travel accommodation information is then stored (step 990) and the operation terminates.

This process may be repeated for each itinerary in the travel itinerary database and may be repeated as often as necessary. For example, the above process may be repeated on a periodic basis, in response to the occurrence of an event, or the like. When an itinerary has been activated but is no longer active, the itinerary is removed from the travel itinerary database and thus, the above process will no longer be performed with regard to that itinerary.

Thus, the present invention provides a mechanism for automatically identifying when changes in travel conditions require modification to downstream segments, of a travel itinerary, or plan e.g., travel accommodations that are based on travel accommodations occurring earlier in the travel itinerary. Moreover, the present invention provides a mechanism for automatically contacting agency or vendor computing systems in order to acquire new travel arrangements or modify existing travel arrangements based on the determination of the required modifications to the downstream segments of the travel itinerary. In this way, the hassle and frustration of the traveler and vendor personnel is reduced by automatically negotiating new travel accommodations when necessary rather than requiring the traveler to personally make the needed changes.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for rescheduling travel arrangements comprising the steps of:
obtaining current travel information for a user to identify a current status of travel of the user;
responsive to a real-time change in status in at least one segment of a prearranged travel plan for the user, determining whether the user has provided a rule set for making changes to downstream segments of the travel plan;
automatically altering the downstream segments of the travel plan according to the rule set, if the user has provided a rule set for making changes to downstream segments of the travel plan; and
automatically contacting at least one agency computing device to modify travel accommodations associated with the travel plan in accordance with the altered downstream segments.

2. The method of claim 1, further comprising:
retrieving the prearranged travel plan from a storage device; and
comparing the prearranged travel plan to the current travel information, wherein a real-time change in status in at least one segment of the prearranged travel plan is determined if a result of the comparison indicates a discrepancy between the prearranged travel plan and the current travel information.

3. The method of claim 1, wherein the prearranged travel plan is obtained as travel arrangements are finalized by a user via at least one web site.

4. The method of claim 1, wherein the prearranged travel plan is obtained by receiving user input to at least one Web form provided by at least one server, identifying information regarding segments of the prearranged travel plan.

5. The method of claim 2, wherein the rule set includes information indicating under what conditions a discrepancy between the prearranged travel plan and the current travel information is to be resolved by altering downstream segments of the prearranged travel plan.

6. The method of claim 5, wherein the rule set further includes information indicating a manner by which a discrepancy is to be resolved.

7. The method of claim 1, wherein automatically contacting at least one agency computing device to modify travel accommodations associated with the travel plan includes:
negotiating with the at least one agency computing device to obtain new travel accommodations; and applying user established preferences to the negotiation with the at least one agency computing device.

8. The method of claim 7, wherein the user established preferences indicate a user preference regarding at least one of a preferred type of travel accommodation and a preferred vendor of a travel accommodation.

9. The method of claim 1, further comprising:
identifying a plurality of prearranged travel plans for a plurality of users in a travel plan storage device;
for each prearranged travel plan, determining if the travel plan is currently active; and
performing the steps of obtaining, determining, altering and contacting for each currently active prearranged travel plan in the travel plan storage device.

10. The method of claim 1, wherein the current travel information is obtained from at least one current travel information source computing device.

11. The method of claim 10, wherein the at least one current travel information source computing device includes at least one of an airline computing system, a travel agency computing system, a transportation provider computing system, a lodging provider computing system, and a government agency computing system.

12. The method of claim 10, wherein the at least one current travel information source includes an Air Route Traffic Control Center (ARTCC) computing system.

13. The method of claim 1, further comprising:
sending a notification to a communication device associated with the user indicating the altered downstream segments of the travel plan and the modified travel accommodations.

14. A system for rescheduling travel arrangements comprising:
means for obtaining current travel information for a user to identify a current status of travel of the user;
means for determining, responsive to a real-time change in status in at least one segment of a prearranged travel plan for the user, whether the user has provided a rule set for making changes to downstream segments of the travel plan;
means for automatically altering the downstream segments of the travel plan according to the rule set, if the user has provided a rule set for making changes to downstream segments of the travel plan; and
means for automatically contacting at least one agency computing device to modify travel accommodations associated with the travel plan in accordance with the altered downstream segments.

15. The system of claim 14, further comprising:
means for retrieving the prearranged travel plan from a storage device; and
means for comparing the prearranged travel plan to the current travel information, wherein a real-time change in status in at least one segment of the prearranged travel plan is determined if a result of the comparison indicates a discrepancy between the prearranged travel plan and the current travel information.

16. The system of claim 15, wherein the rule set includes information indicating under what conditions a discrepancy between the prearranged travel plan and the current travel information is to be resolved by altering downstream segments of the prearranged travel plan.

17. The system of claim 16, wherein the rule set further includes information indicating a manner by which a discrepancy is to be resolved.

18. The system of claim 14, wherein the means for automatically contacting at least one agency computing device to modify travel accommodations associated with the travel plan includes:
means for negotiating with the at least one agency computing device to obtain new travel accommodations; and
means for applying user established preferences to the negotiation with the at least one agency computing device.

19. The system of claim 18, wherein the user established preferences indicate a user preference regarding at least one of a preferred type of travel accommodation and a preferred vendor of a travel accommodation.

20. The system of claim 14, further comprising:
means for identifying a plurality of prearranged travel plans for a plurality of users in a travel plan storage device;
means for determining, for each prearranged travel plan, if the travel plan is currently active; and
means for enabling the means for obtaining, means for determining, means for altering and means for contacting, for each currently active prearranged travel plan in the travel plan storage device.

21. The system of claim 14, wherein the current travel information is obtained from at least one current travel information source computing device.

22. The system of claim 21, wherein the at least one current travel information source computing device includes at least one of an airline computing system, a travel agency computing system, a transportation provider computing system, a lodging provider computing system, and a government agency computing system.

23. The system of claim 21, wherein the at least one current travel information source includes an Air Route Traffic Control Center (ARTCC) computing system.

24. The system of claim 14, further comprising:
means for sending a notification to a communication device associated with the user indicating the altered downstream segments of the travel plan and the modified travel accommodations.

25. A computer program product in a computer readable medium for rescheduling travel arrangements comprising:
first instructions for obtaining current travel information for a user to identify a current status of travel of the user;
second instructions for determining, responsive to a real-time change in status in at least one segment of a prearranged travel plan for the user, whether the user has provided a rule set for making changes to downstream segments of the travel plan;
third instructions for automatically altering the downstream segments of the travel plan according to the rule set, if the user has provided a rule set for making changes to downstream segments of the travel plan; and
fourth instructions for automatically contacting at least one agency computing device to modify travel accommodations associated with the travel plan in accordance with the altered downstream segments.

26. The computer program product of claim 25, further comprising:
fifth instructions for retrieving the prearranged travel plan from a storage device; and
sixth instructions for comparing the prearranged travel plan to the current travel information, wherein a real-time change in status in at least one segment of the prearranged travel plan is determined if a result of the comparison indicates a discrepancy between the prearranged travel plan and the current travel information.

27. The computer program product of claim 25, wherein the fourth instructions for automatically contacting at least one agency computing device to modify travel accommodations associated with the travel plan include:
instructions for negotiating with the at least one agency computing device to obtain new travel accommodations; and
instructions for applying user established preferences to the negotiation with the at least one agency computing device.

28. The computer program product of claim 25, further comprising:
fifth instructions for identifying a plurality of prearranged travel plans for a plurality of users in a travel plan storage device;
sixth instructions for determining, for each prearranged travel plan, if the travel plan is currently active; and
seventh instructions for executing the first, second, third and fourth instructions for each currently active prearranged travel plan in the travel plan storage device.

29. The computer program product of claim 25, further comprising:
fifth instructions for sending a notification to a communication device associated with the user indicating the altered downstream segments of the travel plan and the modified travel accommodations.

30. A method, in a data processing system, of monitoring a travel itinerary of a traveler, comprising:
obtaining current travel condition information;
obtaining a travel itinerary for the traveler;
comparing the current travel condition information to the travel itinerary to identify differences;
applying one or more rules to the differences to determine if a modification of travel accommodations in the travel itinerary are necessary; and
modifying travel accommodations in the travel itinerary if it is determined that a modification of travel accommodations in the travel itinerary is necessary.
